(19) United States
(12) Patent Application Publication
(10) Pub. No.: US 2009/0288034 A1
(43) Pub. Date: Nov. 19, 2009

(54) Locating and Identifying Controls on a Web Page

(75) Inventors: Rhonda L. Childress, Austin, TX (US); David Bruce Kumhyr, Austin, TX (US); Michael John Spisak, East Northport, NY (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation, Armonk, NY (US)

(21) Appl. No.: 12/122,797

(22) Filed: May 19, 2008

(51) Int. Cl. G06F 3/048

(52) U.S. Cl. 715/781

(57) ABSTRACT

An approach is provided that receives Web page data at the user's computer system with the Web page data including graphical user interface (GUI) controls. A process running on the client computer system identifies each of the GUI controls included in the Web page data. A rendered image of the Web page data is displayed in a visible pane on a display device that is connected to the client computer system with some of the GUI controls appearing in the visible pane. A user-controlled highlight is applied to an area on the visible pane proximate to each of the GUI controls that appear in the visible pane in order to highlight the GUI controls. The applied user-controlled highlight includes various visual characteristics that are different from the visual characteristics that are used to display the GUI controls.

### BACKGROUND OF THE INVENTION

1. Technical Field

The present invention relates to Web page navigation. More particularly, the present invention relates to an approach for locating, identifying and visibly highlighting controls for a user of a Web page.

2. Description of the Related Art

Web pages are resources of information available through the Internet and, more specifically, the World Wide Web (WWW), as well as from restricted networks, such as corporate intranets. The information, or content, is usually provided in one or more formats, such as the Hypertext Markup Language (HTML), Extensible Hypertext Markup Language (XHTML), or the like. Web pages are requested and served from web servers typically using a common protocol, such as the Hypertext Transfer Protocol (HTTP).

Web pages can have any variety of layouts, colors, images, and text. Various graphical user interface (GUI) controls can be displayed on a Web page to navigate to other Web pages or perform various functions provided by the Web page. These GUI controls include many different types of controls and may be located virtually anywhere on a Web page. Hypertext links often appear as colored text or may appear as a command button, or any other type of GUI control. Because of the wide variety of Web pages and the ability for GUI controls to have different appearances and be placed anywhere throughout the Web page, a challenge faced by users in using some Web pages, especially those that provide a plethora of information, is distinguishing between actual GUI controls and other images and textual highlights that do not correspond to a GUI control. Web pages that provide “mashups” exacerbate this problem by combining data and/or functionality from more than one source into a single Web page.

### SUMMARY

It has been discovered that the aforementioned challenges are resolved using an approach that receives Web page data at the user's computer system with the Web page data including graphical user interface (GUI) controls. A process running on the client computer system identifies each of the GUI controls included in the Web page data. A rendered image of the Web page data is displayed in a visible pane on a display device that is connected to the client computer system with some of the GUI controls appearing in the visible pane. A user-controlled highlight is applied to an area on the visible pane proximate to each of the GUI controls that appear in the visible pane in order to highlight the GUI controls. The applied user-controlled highlight includes various visual characteristics that are different from the visual characteristics that are used to display the GUI controls.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 depicts a screen layout of a user-configuration dialog used to set various highlight control settings;

FIG. 4 is a sample Web page with a control the user activates to highlight the controls on the page;

FIG. 5 is the sample Web page of FIG. 4 after highlighting has been applied to the various controls;

FIG. 6 is a flowchart showing higher level steps performed by a client computer system when receiving Web page data from a server;

FIG. 7 is a flowchart showing steps taken to process user actions in order to highlight controls on the received Web page;

FIG. 8 is a flowchart showing details of the steps taken to highlight the controls found on a Web page received from the server; and

FIG. 9 is a diagram showing a highlight style sheet being applied to another style sheet to create an overlaid result that highlights controls.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

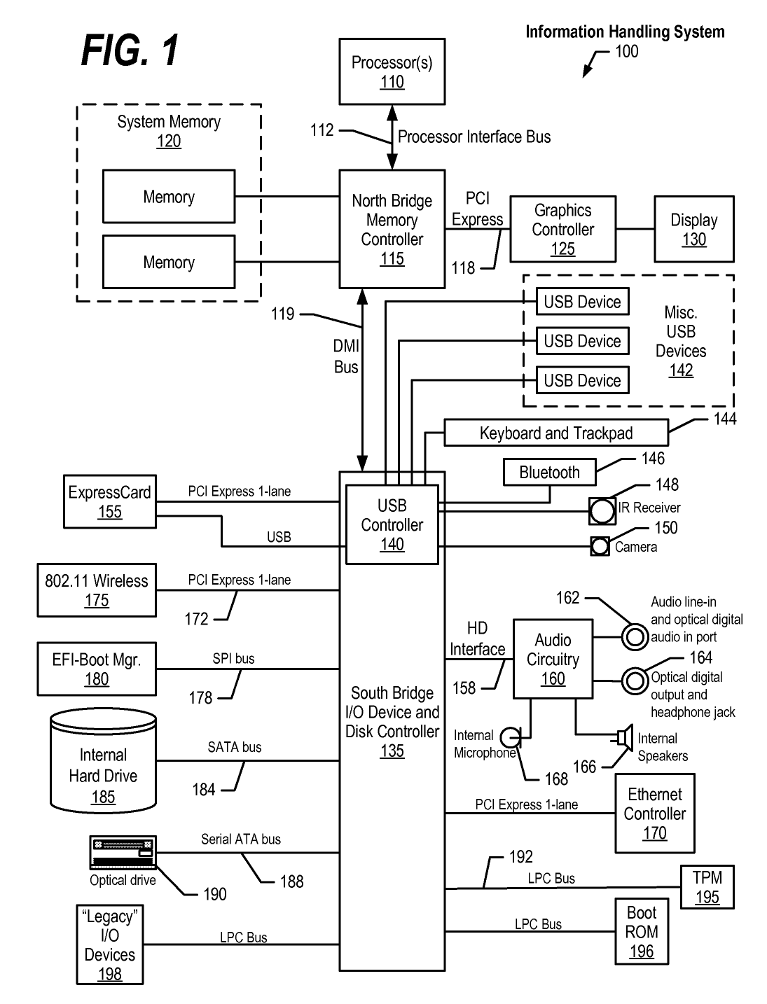

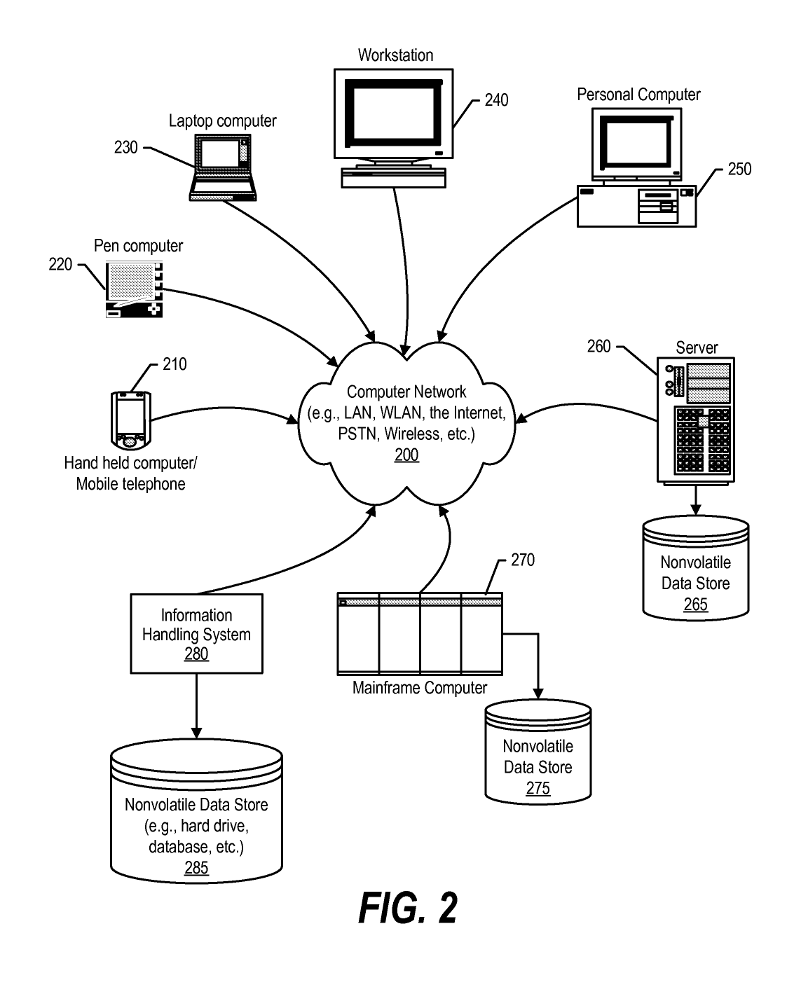

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100 which is a simplified example of a computer system capable of performing the computing operations described herein. Information handling system 100 includes one or more processors 110 which is coupled to processor interface bus 112. Processor interface bus 112 connects processors 110 to Northbridge 115, which is also known as the Memory Controller Hub (MCH). Northbridge 115 is connected to system memory 120 and provides a means for processor(s) 110 to access the system memory. Graphics controller 125 is also connected to Northbridge 115. In one embodiment, PCI Express bus 118 is used to connect Northbridge 115 to graphics controller 125. Graphics controller 125 is connected to display device 130, such as a computer monitor.

Northbridge 115 and Southbridge 135 are connected to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus is used to connect the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses can include PCI and PCI Express busses, an ISA bus, a System Management Bus (SMBus or SMB), a Low Pin Count (LPC) bus. The LPC bus is often used to connect low-bandwidth devices, such as boot ROM 196 and “legacy” I/O devices (using a “super I/O” chip). The “legacy” I/O devices (198) can include serial and parallel ports, keyboard, mouse, floppy disk controller. The LPC bus (bus 192) is also used to connect Southbridge 135 to Trusted Platform Module (TPM) 195. Other components often included in Southbridge 135 include a Direct Memory Access (DMA) controller, a Programmable Interrupt Controller (PIC), a storage device controller, which connects Southbridge 135 to nonvolatile storage device 185, such as a hard disk drive, using bus 184.

ExpressCard 155 is a slot used to connect hot-pluggable devices to the information handling system. ExpressCard 155 supports both PCI Express and USB connectivity as it is connected to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, Bluetooth device 146 which provides for wireless personal area networks (PANs), keyboard and trackpad 144, and other miscellaneous USB connected devices 142, such as a mouse, a removable nonvolatile storage device, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etc.

Wireless Local Area Network (LAN) device 175 is connected to Southbridge 135 via the PCI or PCI Express bus 172. LAN device 175 typically implements one of the IEEE 802.11 standards of over-the-air modulation techniques that all use the same protocol for wireless communication between information handling system 100 and another computer system or device. Optical storage device 190 is connected to Southbridge 135 using Serial ATA (SATA) bus 188. Serial ATA adapters and devices communicate over a high-speed serial link. The Serial ATA bus is also used to connect Southbridge 135 to other forms of storage devices, such as hard disk drives. Audio circuitry 160, such as a sound card, is connected to Southbridge 135 via bus 158. Audio circuitry 160 is used to provide functionality such as audio line-in and optical digital audio in port 162, optical digital output and headphone jack 164, internal speakers 166, and internal microphone 168. Ethernet controller 170 is connected to Southbridge 135 using a bus, such as the PCI or PCI Express bus. Ethernet controller 170 is used to connect information handling system 100 with a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems which operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling system include nonvolatile data stores, such as hard drives and/or nonvolatile memory. Some of the information handling systems shown in FIG. 2 are depicted with separate nonvolatile data stores (server 260 is shown with nonvolatile data store 265, mainframe computer 270 is shown with nonvolatile data store 275, and information handling system 280 is shown with nonvolatile data store 285). The nonvolatile data store can be a component that is external to the various information handling systems or can be internal to one of the information handling systems. In addition, removable nonvolatile storage device 145 can be shared amongst two or more information handling systems using various techniques, such as connecting the removable nonvolatile storage device 145 to a USB port or other connector of the information handling systems.

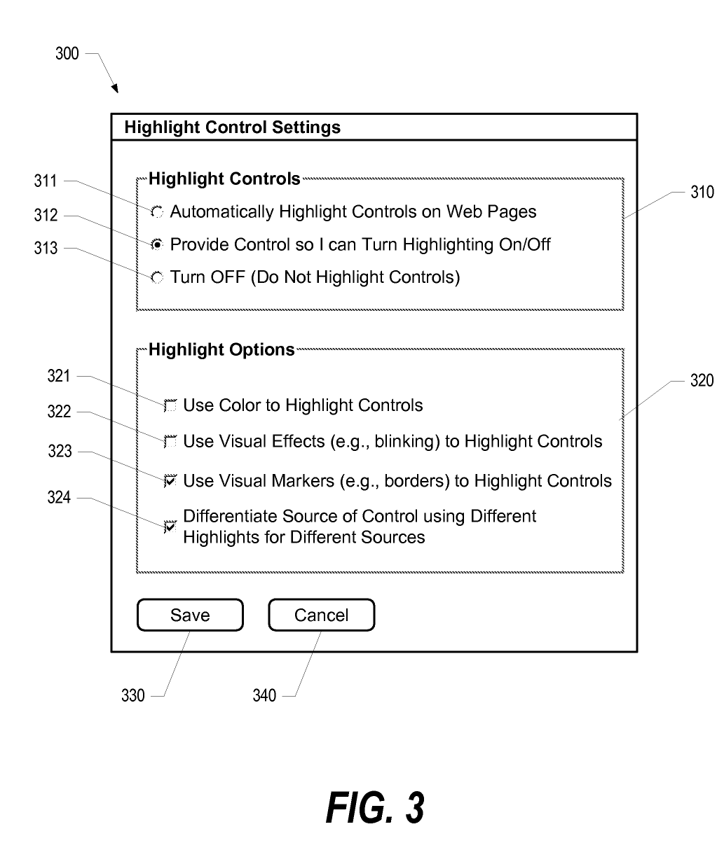

FIG. 3 depicts a screen layout of a user-configuration dialog used to set various highlight control settings. Screen layout 300 includes two sections of control settings. Screen section 310 is a radio-button grouping where the user can select one of the option buttons with choices that include (option 311) automatically having the system highlight the controls that appear on Web pages, (option 312) providing a control so that the user can turn highlighting on or off on a particular Web page, and (option 313) turning off the highlight control mechanism so that controls that appear on Web pages are not highlighted. Screen section 320 shows various highlighting options that the user can choose. These highlight options include check box control 321 to use colors to highlight controls, check box control 322 to use visual effects (e.g., blinking, etc.) to highlight controls, check box control 323 to use visual markers (e.g., borders, etc.) to highlight controls, and check box control 324 to use different highlights to differentiate between different sources on a Web page. In the example shown, the user has selected to use visual markers, such as borders, to highlight controls as well as to differentiate between sources of controls using different highlights by selecting both check boxes 323 and 324. Using these selections, when a Web page is displayed with controls from two sources (e.g., Source “A” and Source “B”), controls from Source A might be highlighted with dashed-line borders encircling the Source A controls, while controls from Source B might be highlighted with dotted-line borders encircling the Source B controls. As shown, more than one highlight option can be selected by a user.

When the user wishes to save the highlight control settings, the user selects “save” command button 330. On the other hand, if the user wishes to exit the dialog without saving the settings, the user selects “cancel” command button 340.

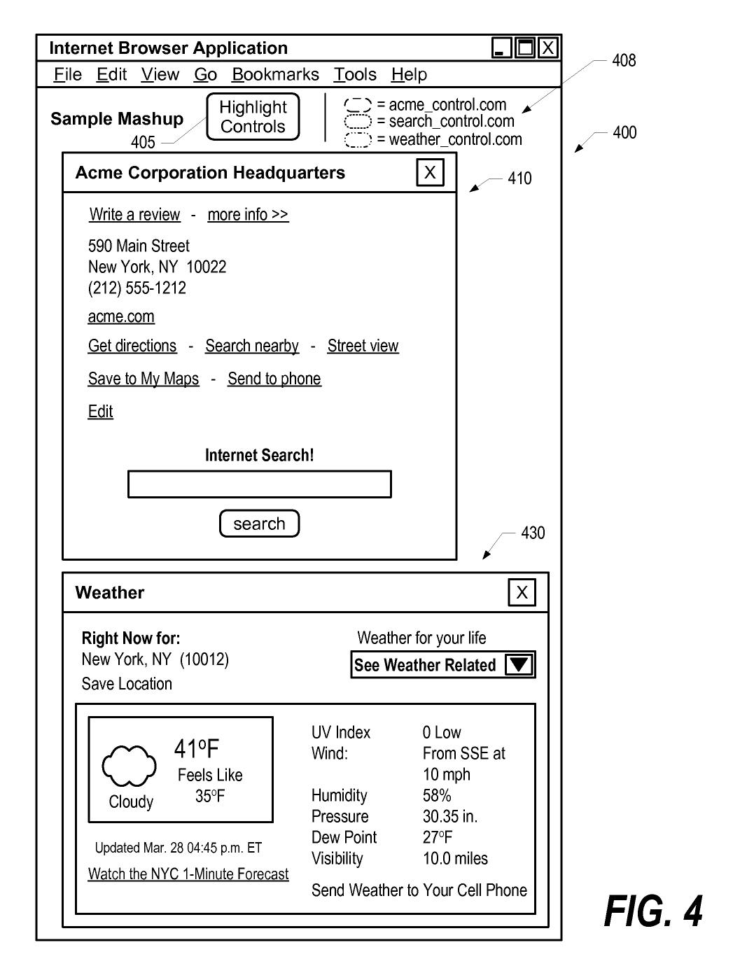

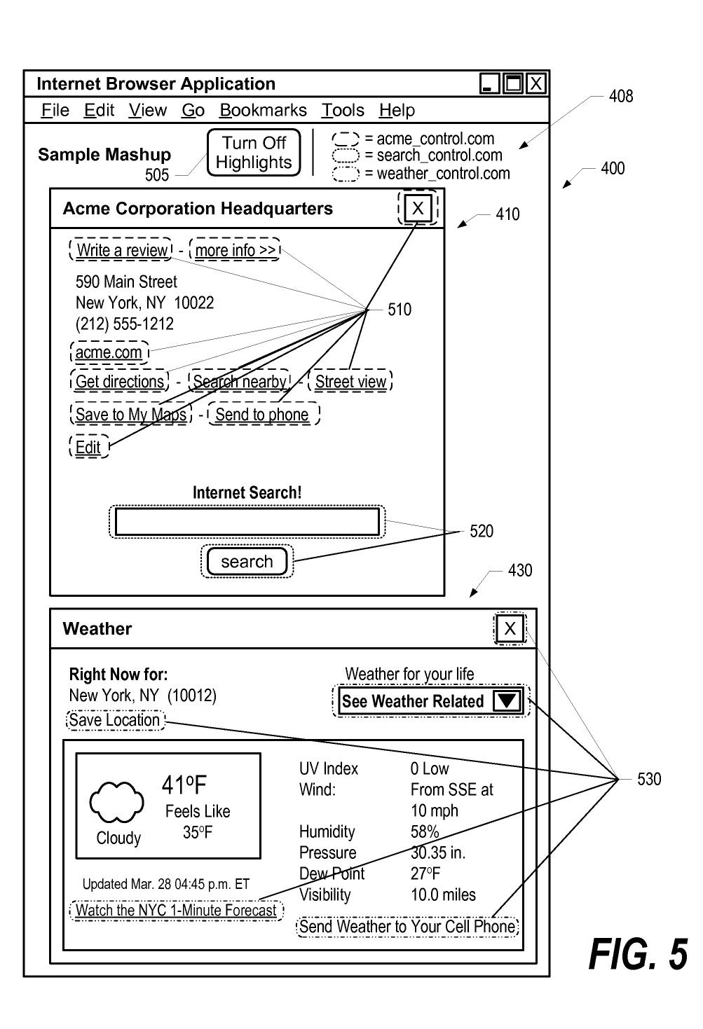

FIG. 4 is a sample Web page with a control the user activates to highlight the controls on the page. Web browser 400 includes two Web pages—Web page 410 and Web page 430. In addition, command button 405 is included on the Web page or, in another environment, is available from a menu or other control provided by the Web browser application. Also, the sample Web pages shown are from three different sources—“acme_control.com,” “search_control.com,” and “weather_control.com” as noted in legend area 408. As control 405 indicates, the various controls displayed in Web pages 410 and 430 will be highlighted when the user selects control 405. This control is provided because the user selected to have manual control over the highlighting of GUI controls (see option 312 in FIG. 3). As can be seen, without highlighting the controls in Web pages 410 and 430, it can be difficult for the user to differentiate between plain text and actual controls that, when selected, provide a function such as navigate to a different Web page. In order to highlight the controls when the user is viewing Web pages 410 and 430, the user selects command button 405 which results in the controls on Web pages 410 and 430 being highlighted as shown in FIG. 5.

FIG. 5 is the sample Web page of FIG. 4 after highlighting has been applied to the various controls. Each of the controls found of Web pages 410 and 430 is now highlighted and the highlight, in this case a visible border encircling the individual controls, is displayed. In addition, the border style is different depending on the source of the control. As shown, controls 510 are encircled with a dashed border indicating, as described in legend 408, that these controls are from the source “acme_control.com.” Likewise, controls 520 are encircled with a dotted border indicating, as described in legend 408, that these controls are from the source “search_control.com.” Finally, controls 530 are encircled with a dotted-dashed border indicating, as described in legend 408, that these controls are from the source “weather_control.com.” Now, the command button has toggled with the text now indicating that command button 505, when selected by the user, will act to turn off highlights of the various controls.

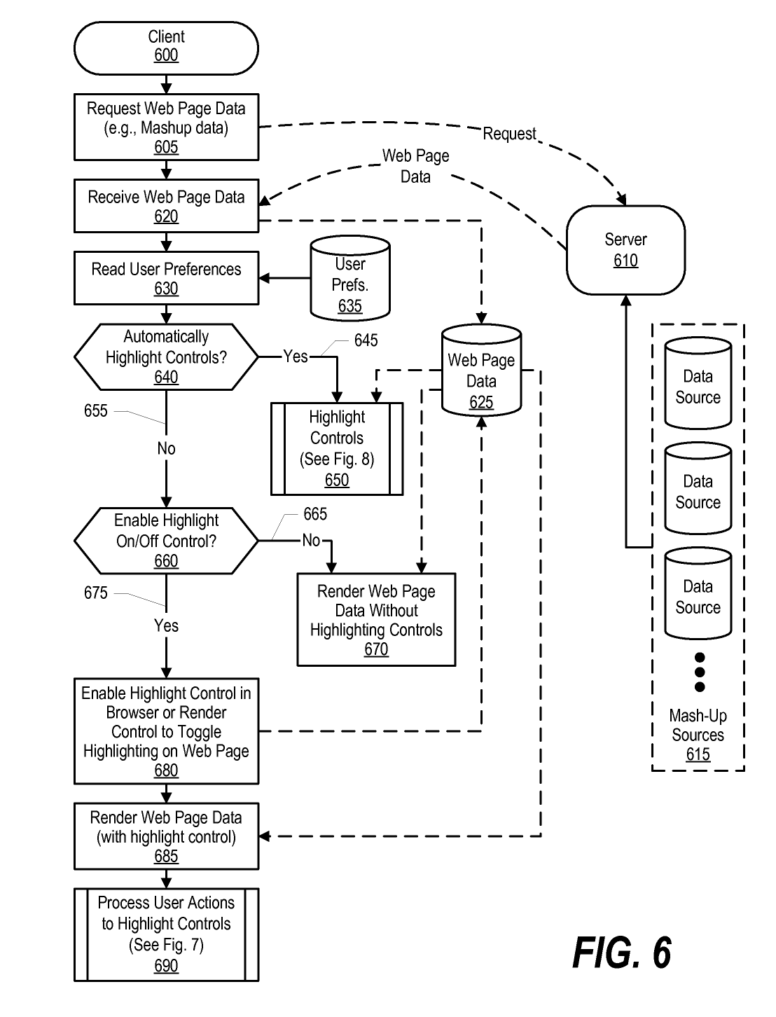

FIG. 6 is a flowchart showing higher level steps performed by a client computer system when receiving Web page data from a server. Client computer system processing commences at 600 whereupon, at step 605, the client requests a Web page, such as a Web page that includes mashup data, from server 610. Server 610 receives the client's request, retrieves data from one or more data sources 615, builds a Web page and returns it to the client. In the case of mashup data, server 610 mashes Web page data originating from multiple sources into one or more Web pages that are returned to client 600. In a mashup embodiment, the step of receiving data sometimes includes receiving data from multiple servers (610) each of which is querying one or more data stores 615 and returning the mashup data to the client computer system.

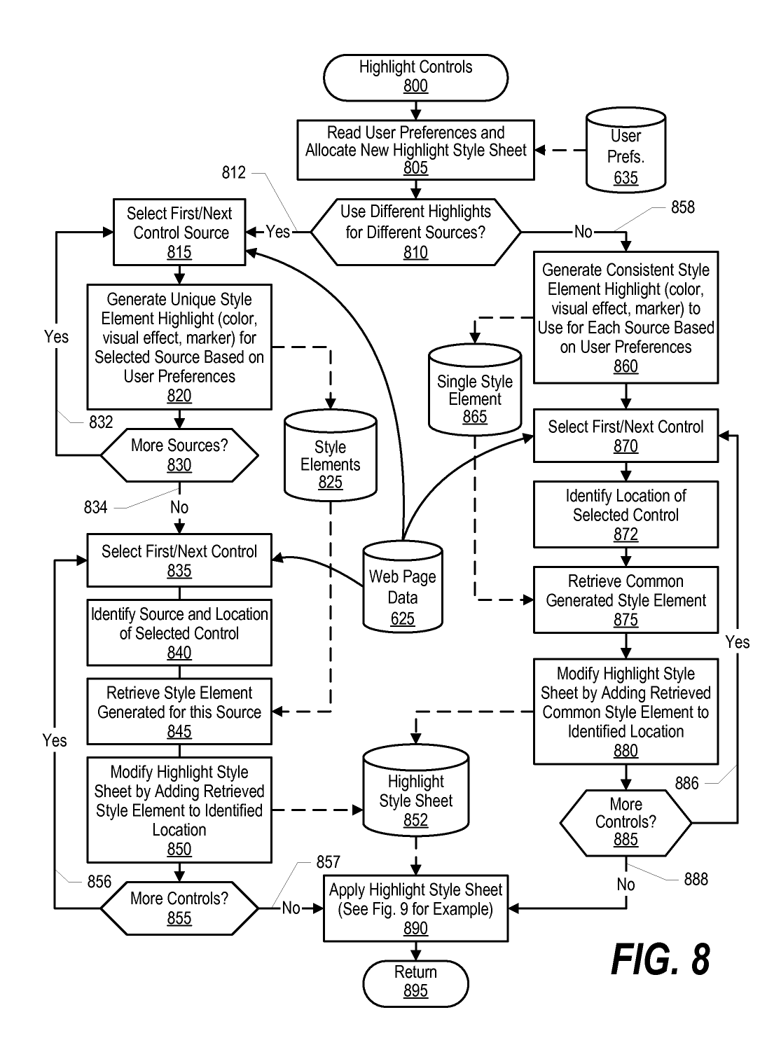

Returning to client processing, at step 620, the client computer system receives the Web page data (e.g., mashup data) provided by server 610 (or, as described above, multiple servers) and stores the received Web page data in data store 625, such as a memory area of disk file. At step 630, the client computer system reads user preferences 635, such as the preferences previously described and shown on FIG. 3. A determination is made, based on the user's preferences, as to whether the user has requested automatic highlighting of controls that appear on the Web page (decision 640). If the user has requested automatic highlighting, then decision 640 branches to “yes” branch 645 whereupon, at predefined process 650 the controls that appear on the Web page are automatically highlighted according to the user's preferences (e.g., blinking, bordered, etc., see FIG. 8 and corresponding text for processing details).

On the other hand, if the user has not requested automatic highlighting of controls that appear on the Web page, then decision 640 branches to “no” branch 655 whereupon a determination is made as to whether, based on the user's preferences, the user wishes to enable manual highlighting of controls that appear on the Web page using a toggle mechanism (decision 660). If the user does not wish to enable manual highlighting of controls, then decision 660 branches to “no” branch 665 whereupon, at step 670, Web page data 625 is rendered without any highlighting of the controls that appear on the Web pages.

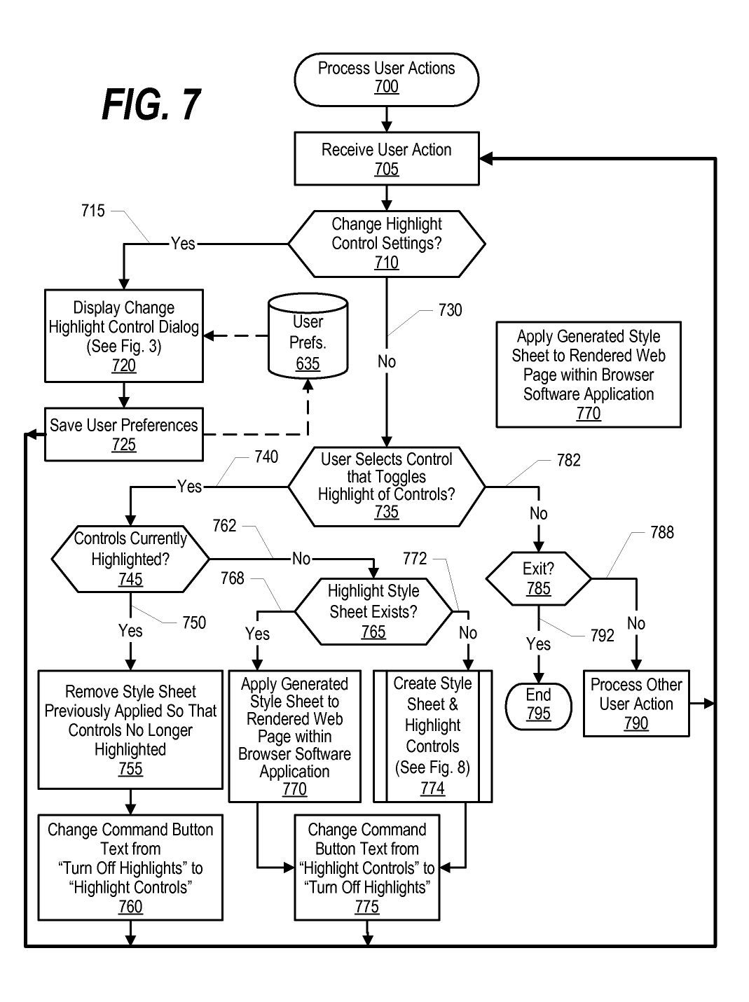

If, on the other hand, the user wishes to enable manual highlighting of controls that appear on the Web page, then decision 660 branches to “yes” branch 675 whereupon, at step 680, a highlight control (e.g., a command button that allows the user to select whether highlighting is turned “on” or “off”) is enabled in the user's browser software application or, if such ability does not exist in the browser software application, a control is created and rendered onto the Web page that, when selected by the user, causes the highlighting of the controls to toggle (on/off). Command buttons 405 in FIGS. 4 and 505 in FIG. 5 provide an example of such a control rendered onto the Web page. Returning to FIG. 6, at step 685, Web page data 625 is rendered along with any control that may have been included in the Web page data during the processing performed at step 680. At predefined process 690, the Web page is rendered using the Web browser software application running on the client's computer system and the user's actions are processed to turn highlighting of controls on or off (see FIG. 7 and corresponding text for processing details).

FIG. 7 is a flowchart showing steps taken to process user actions in order to highlight controls on the received Web page. Processing commences at 700 whereupon, at step 705, a user action is received (e.g., intercepted). A determination is made as to whether the user has requested to change the highlight control settings (decision 710). If the user has requested to change the highlight control settings, then decision 710 branches to “yes” branch 715 whereupon, at step 720, the dialog used to change the highlight control settings is displayed by reading the current (or default) user preferences from user preferences data store 635 and displaying the dialog shown in FIG. 3. Once the user changes the preferences and requests to “save” the changes, then, at step 725, the user preferences are saved back to user preferences data store 635. Processing then loops back to receive (intercept) the next user action/request.

Returning to decision 710, if the request by the user was not to change the highlight control settings, then decision 710 branches to “no” branch 730 whereupon a determination is made as to whether the user has selected a control that is used to toggle the highlighting of the controls that appear on the Web page (decision 735). If the user has selected a control that toggles the highlighting of the controls that appear on the Web page (e.g., by using command button 405 or 505 that are shown in FIGS. 4 and 5, respectively), then decision 735 branches to “yes” branch 740 whereupon a determination is made as to whether the controls that appear on the Web page are currently being highlighted (decision 745). If the controls are currently being highlighted then decision 745 branches to “yes” branch 750 whereupon, at step 755, the style sheet that was previously applied in order to highlight the controls is removed so that the controls are no longer highlighted and, at step, 760 the command button text is changed (toggled) so that it now reads “Highlight controls” rather than “Turn off highlights.” Processing then loops around to receive (intercept) the next user action/request.

Returning to decision 745, if the controls are not currently highlighted on the Web pages, then decision 745 branches to “no” branch 762 whereupon a determination is made as to whether the style sheet used to highlight the controls has already been created (decision 765). If the style sheet used to highlight the controls already exists, then decision 765 branches to “yes” branch 768 whereupon, at step 770, the already-generated style sheet is applied to the rendered Web page in the browser software application in order to highlight the controls that appear on the Web page. On the other hand, if the style sheet has not already been created, then decision 765 branches to “no” branch 772 whereupon, at predefined process 774, the style sheet used to highlight the controls is created and the controls that appear on the Web page are highlighted using the newly created style sheet (see FIG. 8 and corresponding text for processing details). After the style sheet has been applied (either at step 770 or predefined process 774), the command button text is changed (toggled) so that it now reads “Turn off highlights” rather than “Highlight controls.” Processing then loops around to receive (intercept) the next user action/request.

Returning to decision 735, if the user has not requested to toggle the highlight of controls that appear on the Web page, then decision 735 branches to “no” branch 782 whereupon a determination is made as to whether the user is exiting the Web page (decision 785). If the user is exiting the Web page (e.g., closing the browser software application), then decision 785 branches to “yes” branch 792 whereupon processing ends at 795. On the other hand, if the user is requesting some other action, then decision 785 branches to “no” branch 788 whereupon, at step 790, the other action is processed and processing loops back to receive (intercept) the next user action/request.

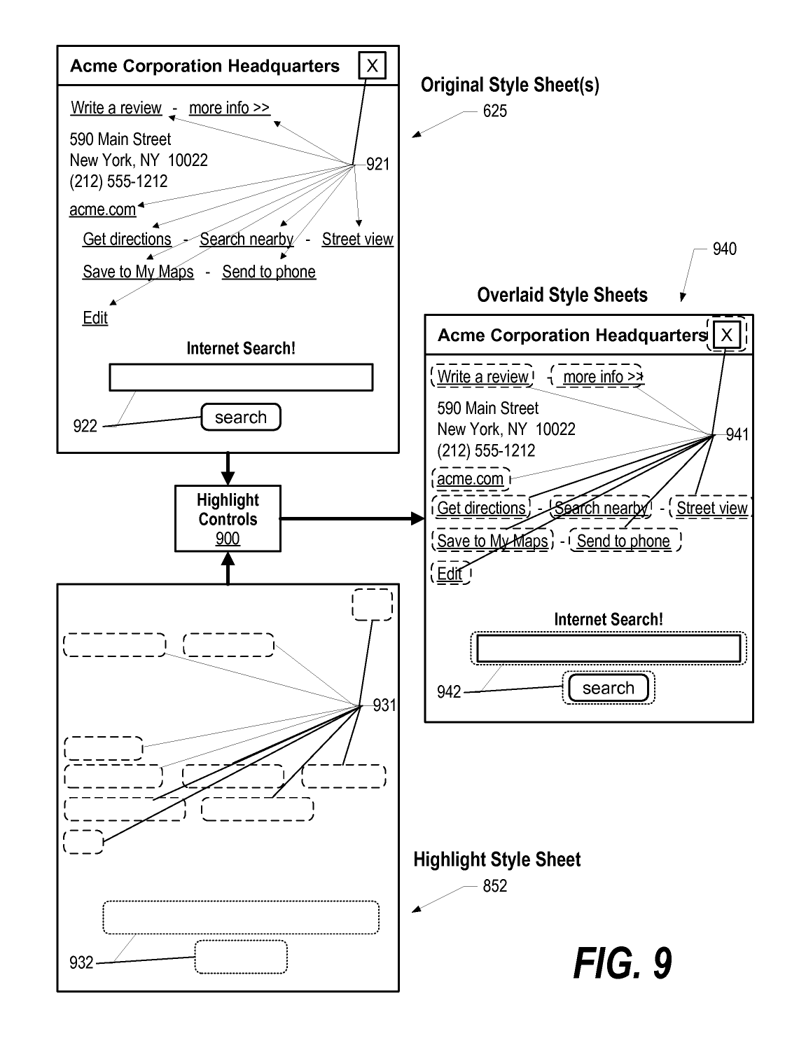

FIG. 8 is a flowchart showing details of the steps taken to highlight the controls found on a Web page received from the server. Processing commences at 800 whereupon, at step 805, user preferences data store 635 are read and a new style sheet is allocated. The new highlight style sheet will include style elements used to highlight user controls. For an example of this highlight style sheet, see highlight style sheet 930 on FIG. 9.

Returning to FIG. 8, a determination is made as to whether, based on the user preferences, the user wishes to use different highlights for different sources of the controls that appear on the Web page (decision 810). If the user wishes to use different highlights based on the source of the control, then decision 810 branches to “yes” branch 812 whereupon, at step 815, the first control source is selected from Web page data 625 (e.g., mashup data). At step 820, a unique style element highlight is created for the selected source with the highlighting based on the user's highlight preferences (e.g., different colors, borders, etc.) and stored in style elements data store 825, such as a memory area or a disk file. A determination is made as to whether there are more sources of controls in the Web page data (decision 830). If there are more sources, then decision 830 branches to “yes” branch 832 which loops back to select the next source from Web page data 625 and create a new style element for the newly selected source which is then stored in style elements data store 825. This looping continues until there are no more sources to process, at which point decision 830 branches to “no” branch 834.

At step 835, the first control is selected from Web page data 625. At step 840, the source and location of the selected control are identified. At step 845, the style element that was created for this source is retrieved from style elements data store 825. At step 850, highlight style sheet 852 is modified by adding the retrieved style element (e.g., color overlay, border, etc.) to the identified location of the control. A determination is made as to whether there are more controls in Web page data 625 to process (decision 855). If there are more controls to process, then decision 855 branches to “yes” branch 856 which loops back to select and process the next control from Web page data 625 and add another style element to highlight style sheet 852. This looping continues until all controls from Web page data 625 have been processed, at which point decision 855 branches to “no” branch 857 whereupon, at step 890, newly created highlight style sheet 852 is applied by rendering the highlight style sheet using the browser software application along with the style sheets included in Web page data 625. Processing then returns at 895.

Returning to decision 810, if the user does not want to use different highlights for different sources and would rather use the same visual effects to highlight controls irregardless of the source of the control, then decision 810 branches to “no” branch 858 whereupon, at step 860, a single style element is generated based on the user's preferences (e.g., blinking, color overlay, border, etc.) and stored in single style element data store 865, such as a memory area or disk file. At step 870, the first control is selected from Web page data 625. At step 872, the location of the selected control is identified. At step 875, the common generated style element is retrieved and, at step 880, highlight style sheet 852 is modified by adding the retrieved common style element (e.g., color overlay, border, etc.) to the identified location of the control. A determination is made as to whether there are more controls in Web page data 625 to process (decision 885). If there are more controls to process, then decision 885 branches to “yes” branch 886 which loops back to select and process the next control from Web page data 625 and add another style element to highlight style sheet 852. This looping continues until all controls from Web page data 625 have been processed, at which point decision 885 branches to “no” branch 888 whereupon, at step 890, newly created highlight style sheet 852 is applied by rendering the highlight style sheet using the browser software application along with the style sheets included in Web page data 625. Processing then returns at 895.

FIG. 9 is a diagram showing a highlight style sheet being applied to another style sheet to create an overlaid result that highlights controls. Original style sheet 625 shows an example of a style sheet that is rendered in order to display Web page data without highlighting the controls. Controls 921 are controls that originate from a first source and controls 922 are controls that originate from a second source, with both controls being included in Web page data 625.

Highlight style sheet 852 is an example of a highlight style sheet that is generated using the processing shown in FIG. 8. Using the processing that differentiates between control sources using different highlight visual effects, highlight style sheet 852 includes highlight style elements 931 that are used to highlight controls from the first source by encircling the controls with a dashed border, and includes highlight style elements 932 that are used to highlight controls from the second source by encircling the controls with a dotted border. When highlighting of controls is requested at step 900 (e.g., automatic highlighting or user-directed highlighting as depicted in FIG. 7), then highlight style sheet is applied to original style sheets 625 resulting in overlaid style sheets 940 that highlights controls (highlights 941 use a first visual effect to highlight controls from the first source and highlights 942 use a second visual effect to highlight controls from the second source).

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by a computer system, said method comprising:
receiving, at the computer system, Web page data that includes a plurality of graphical user interface (GUI) controls;
identifying each of the GUI controls included in the Web page data;
displaying a rendered image of the Web page data in a visible pane on a display device connected to the client computer system, wherein one or more of the GUI controls appears in the visible pane; and
applying a user-controlled highlight to an area on the visible pane proximate to each of the one or more GUI controls that appear in the visible pane, wherein the applied user-controlled highlight includes a first set of one or more visual characteristics that are different from a second set of one or more visual characteristics used to display the GUI controls.

2. The method of claim 1 further comprising:
receiving, at the computer system, a first set of one or more style sheets that include the Web page data and the GUI controls;
generating, at the computer system, a highlight style sheet, wherein the generated style sheet includes a plurality of highlight style elements, wherein each of the highlight style elements corresponds to one of the GUI controls; and
rendering the first set of style sheets and the generated highlight style sheet to create the rendered image, wherein the rendered image appears with both the GUI controls and highlight style elements visible on the visible pane of the display device.

3. The method of claim 2 wherein the rendering is performed in response to receiving a user request to highlight controls on the Web page.

4. The method of claim 2 further comprising:
after the rendering, receiving a request from a user to remove highlighting of controls;
in response to receiving the remove highlighting request:
rendering the first set of style sheets without the generated highlight style sheet to create a re-rendered image, wherein the re-rendered image appears with the GUI controls and does not include the highlight style elements; and
displaying the re-rendered image on the display device, wherein the GUI controls are not highlighted in the re-rendered image.

5. The method of claim 2 further comprising:
identifying a plurality of control locations in the first set of style sheets, wherein each of the control locations corresponds to a position of one of the plurality of GUI controls in the first set of style sheets; and
setting each of the highlight style elements in the generated highlight style sheet to a plurality of proximate locations, wherein each of the proximate locations is proximate to the identified control location of the GUI control that corresponds to the highlight style element.

6. The method of claim 1, wherein the user-controlled highlight includes a first user-controlled highlight and a second user-controlled highlight, and the method further comprising:
identifying a first source and a second source corresponding to each of the GUI controls, wherein the Web page data is a mash-up of data originating from the first and second sources;
selecting a first and a second subset of visual characteristics from the first set of visual characteristics, wherein the selected first and second subsets of visual characteristics are different from each other and wherein the first subset of visual characteristics is applied to the identified GUI controls of the first source, and where the second subset of visual characteristics is applied to the identified GUI controls of the second source; and
displaying the first and second user-controlled highlights on the visible pane in the area proximate to each of the GUI controls so that the GUI controls corresponding to the first source are differentiated from the GUI controls corresponding to the second source by the first and second subset of visual characteristics.

7. The method of claim 6 wherein the first set of visual characteristics is selected from the group consisting of a blinking screen area, a border, a fill color, and a fill pattern.

8. A information handling system comprising:
one or more processors;
a memory accessible by at least one of the processors;
a nonvolatile storage device accessible by at least one of the processors;
a network adapter that connects the information handling system to a computer network;
a display device accessible by at least one of the processors;
a set of instructions which are loaded into the memory and executed by at least one of the processors in order to perform actions of:
receiving, at the information handling system's network adapter, Web page data that includes a plurality of graphical user interface (GUI) controls;
identifying each of the GUI controls included in the Web page data;
displaying a rendered image of the Web page data in a visible pane on the display device, wherein one or more of the GUI controls appears in the visible pane; and
applying a user-controlled highlight to an area on the visible pane proximate to each of the one or more GUI controls that appear in the visible pane, wherein the applied user-controlled highlight includes a first set of one or more visual characteristics that are different from a second set of one or more visual characteristics used to display the GUI controls.

9. The information handling system of claim 8 wherein the set of instructions executed by the processors perform additional actions comprising:
receiving, at the information handling system's network adapter, a first set of one or more style sheets that include the Web page data and the GUI controls;
generating, by one or more of the processors, a highlight style sheet stored in the memory, wherein the generated style sheet includes a plurality of highlight style elements, wherein each of the highlight style elements corresponds to one of the GUI controls; and
rendering the first set of style sheets and the generated highlight style sheet to create the rendered image, wherein the rendered image appears with both the GUI controls and highlight style elements visible on the visible pane of the display device.

10. The information handling system of claim 9 wherein the rendering is performed in response to receiving a user request to highlight controls on the Web page.

11. The information handling system of claim 9 wherein the set of instructions executed by the processors perform additional actions comprising:
after the rendering, receiving a request from a user of the information handling system to remove highlighting of controls;
in response to receiving the remove highlighting request:
rendering the first set of style sheets without the generated highlight style sheet to create a re-rendered image, wherein the re-rendered image appears with the GUI controls and does not include the highlight style elements; and
displaying the re-rendered image on the display device, wherein the GUI controls are not highlighted in the re-rendered image.

12. The information handling system of claim 9 wherein the set of instructions executed by the processors perform additional actions comprising:
identifying a plurality of control locations in the first set of style sheets, wherein each of the control locations corresponds to a position of one of the plurality of GUI controls in the first set of style sheets; and
setting each of the highlight style elements in the generated highlight style sheet to a plurality of proximate locations, wherein each of the proximate locations is proximate to the identified control location of the GUI control that corresponds to the highlight style element.

13. The information handling system of claim 8, wherein the user-controlled highlight includes a first user-controlled highlight and a second user-controlled highlight, and wherein the set of instructions executed by the processors perform additional actions comprising:
identifying a first source and a second source corresponding to each of the GUI controls, wherein the Web page data is a mash-up of data originating from the first and second sources;
selecting a first and a second subset of visual characteristics from the first set of visual characteristics, wherein the selected first and second subsets of visual characteristics are different from each other and wherein the first subset of visual characteristics is applied to the identified GUI controls of the first source, and where the second subset of visual characteristics is applied to the identified GUI controls of the second source; and
displaying the first and second user-controlled highlights on the visible pane in the area proximate to each of the GUI controls so that the GUI controls corresponding to the first source are differentiated from the GUI controls corresponding to the second source by the first and second subset of visual characteristics.

14. A computer program product stored in a computer readable medium, comprising functional descriptive material that, when executed by an information handling system, causes the information handling system to perform actions that include:
receiving, at the computer system, Web page data that includes a plurality of graphical user interface (GUI) controls;
identifying each of the GUI controls included in the Web page data;
displaying a rendered image of the Web page data in a visible pane on a display device connected to the client computer system, wherein one or more of the GUI controls appears in the visible pane; and
applying a user-controlled highlight to an area on the visible pane proximate to each of the one or more GUI controls that appear in the visible pane, wherein the applied user-controlled highlight includes a first set of one or more visual characteristics that are different from a second set of one or more visual characteristics used to display the GUI controls.

15. The computer program product of claim 14 further comprising functional descriptive material that causes the information handling system to perform additional actions that include:
receiving, at the computer system, a first set of one or more style sheets that include the Web page data and the GUI controls;
generating, at the computer system, a highlight style sheet, wherein the generated style sheet includes a plurality of highlight style elements, wherein each of the highlight style elements corresponds to one of the GUI controls; and
rendering the first set of style sheets and the generated highlight style sheet to create the rendered image, wherein the rendered image appears with both the GUI controls and highlight style elements visible on the visible pane of the display device.

16. The computer program product of claim 15 wherein the rendering is performed in response to receiving a user request to highlight controls on the Web page.

17. The computer program product of claim 15 further comprising functional descriptive material that causes the information handling system to perform additional actions that include:
after the rendering, receiving a request from a user to remove highlighting of controls;
in response to receiving the remove highlighting request:
rendering the first set of style sheets without the generated highlight style sheet to create a re-rendered image, wherein the re-rendered image appears with the GUI controls and does not include the highlight style elements; and
displaying the re-rendered image on the display device, wherein the GUI controls are not highlighted in the re-rendered image.

18. The computer program product of claim 15 further comprising functional descriptive material that causes the information handling system to perform additional actions that include:
identifying a plurality of control locations in the first set of style sheets, wherein each of the control locations corresponds to a position of one of the plurality of GUI controls in the first set of style sheets; and
setting each of the highlight style elements in the generated highlight style sheet to a plurality of proximate locations, wherein each of the proximate locations is proximate to the identified control location of the GUI control that corresponds to the highlight style element.

19. The computer program product of claim 14, wherein the user-controlled highlight includes a first user-controlled highlight and a second user-controlled highlight, and further comprising functional descriptive material that causes the information handling system to perform additional actions that include:
identifying a first source and a second source corresponding to each of the GUI controls, wherein the Web page data is a mash-up of data originating from the first and second sources;
selecting a first and a second subset of visual characteristics from the first set of visual characteristics, wherein the selected first and second subsets of visual characteristics are different from each other and wherein the first subset of visual characteristics is applied to the identified GUI controls of the first source, and where the second subset of visual characteristics is applied to the identified GUI controls of the second source; and
displaying the first and second user-controlled highlights on the visible pane in the area proximate to each of the GUI controls so that the GUI controls corresponding to the first source are differentiated from the GUI controls corresponding to the second source by the first and second subset of visual characteristics.

20. The computer program product of claim 19 wherein the first set of visual characteristics is selected from the group consisting of a blinking screen area, a border, a fill color, and a fill pattern.
